(19) United States
(12) Patent Application Publication
(10) Pub. No.: US 2020/0369894 A1
(43) Pub. Date: Nov. 26, 2020

(54) MULTI-FUNCTIONAL ADDITIVE AND LIGHT STABILIZER FOR CHEMICAL COATING COMPOSITIONS

(71) Applicant: PISON STREAM SOLUTIONS INC., Brecksville, OH (US)

(72) Inventors: Joseph H. James, New York, NY (US); Sanjana Das, New York, NY (US)

(21) Appl. No.: 16/420,827

(22) Filed: May 23, 2019

(51) Int. Cl. C09D 7/48; C08K 9/02; C08L 63/00; C08L 67/03; C09D 5/03; C09D 5/32; C09D 7/63; C09D 7/40; C09D 7/62; C08K 5/3475

(52) U.S. Cl. CPC C09D 7/48; C08K 9/02; C08L 63/00; C08L 67/03; C09D 5/036; C08L 75/04; C09D 7/63; C09D 7/69; C09D 7/62; C08K 5/3475; C09D 5/32

(57) ABSTRACT

An ultraviolet absorbing additive is described for chemical compositions. The additive is provided in powdered form, preferably adhered to a silica carrier, thereby allowing it to be introduced into powdered and liquid coating formulations. The additive itself comprises at least 50 wt. % of base resins, including polyester, carboxylated polyester, and epoxy, thereby lending enhanced utility and functionality in ancillary areas such as improved physical properties, flow characteristics, strong weathering resistance, gloss control, yellowing-resistance, and protection against thermal and light degradation.

### FIELD AND BACKGROUND OF INVENTION

The invention relates to additives for chemical coating compositions and, more specifically, to an additive providing improved ultraviolet radiation absorption and light stabilization, along with selected other functions, in films formed by powder and liquid coating formulations.

Powder coating compositions are dry, free-flowing powders. In use, these powders are applied to a substrate (e.g., electrostatic spraying, fluidized bed coating, and/or hot flocking), which is then heated. This added energy causes the powder to melt, flow, and fuse into a continuous film. Advantageously, this procedure results in a robust film with good adhesion, while effectively eliminating the need to rely upon solvents (and particularly volatile organic compounds). Known ways for applying such compositions prior to film formation include electrostatic spraying, fluidized bed coating, and hot flocking.

One type of powder composition is composed of a primary resin or resins, including epoxy, epoxy-polyester, urethane-polyester, TGIC-free polyesters and acrylic coating materials. “TGIC-free” refers to resins which are free of triglycidylisocyanurate. Other components or constituents include curatives, flow aids, catalysts, pigments, hardeners, fillers, gloss control agents, and charge inhibitors. In operation, the resins melt and fuse together, while the additives facilitate various underlying attributes during or after fusion, all with the goal of creating a chemically non-reactive, durable, and continuous coating wherever the composition is applied to the substrate. In some instances, the formulation may be created to allow the composition to be used as a solid, dry powder or, by suspending or otherwise mixing that powder with a liquid carrier, in a liquid form.

Conventional formulations often rely on additives to impart a specific function to the coating composition, such as wetting, flow characteristics (e.g., viscosity, etc.), surface hardness, or other traits. In these prior art compositions, a separate coating additive was required to impart just one of these functions, with the additive usually becoming effective upon curing within the composition during application.

Because the base resins create the bulk of final film (whether the composition is initially applied in powder or liquid form), it is generally thought to be desirable to maximize the amount of base resin. In contrast, and especially to the extent that additives typically cost more and/or present unique formulation challenges in comparison to the base resins, additives tend to be used in their purest possible form but at the lowest possible levels while still delivering the desired attributes. However, the addition of one particular additive may adversely affect the flow or curing characteristics of the composition to which it is added, thereby requiring formulators to add a variety of other additives to mitigate these effects.

One particular concern is that many polymeric materials (both base resins and, in some cases, additives having polymeric or resin constituents) can be attacked by ultraviolet light and/or other radiation. As used herein, ultraviolet (UV) refers to radiation emitted by any source but, most commonly, it is delivered by/associated with sunlight. UV radiation typically has a wavelength anywhere between 100 and 400 nanometers (although shorter wavelength UV radiation caused by sunlight—about 100 to 280 nanometers—is usually absorbed by the earth's atmosphere). More generally speaking, UV radiation falls between visible light radiation and X-rays on the electromagnetic spectrum. Notably, over time, most forms of visible and invisible light radiation have the potential to harm already-cured chemical coatings.

Over time, light radiation can cause resins—and, by extension, the films formed therefrom—to crack or disintegrate unless some sort of protective element is provided. Radiation might also affect the other additives in chemical coatings, especially certain pigments and dyes (e.g., fading, changes in color, etc.), further reducing their functionality after being applied/cured and their shelf life prior to use. Thus, an additive (or light stabilizer) that absorbs unwanted radiation and mitigates these effects stabilizes any coating to which it is added. However, the use of additives to mitigate the effects of UV and/or other radiation should not be confused with a subclass of coating formulations that are actually cured and hardened by UV light.

A number of ultraviolet (UV) protective additives are known. To the extent some prior solutions might include separate top coatings, these add an additional processing step (i.e., application and curing), which increases the cost and adds time. More generally, known ultraviolet light absorbers (UVA) constituents can't deliver other characteristics provided by typical coating additives, such as impact resistance, reducing/eliminating surface defects, weathering resistance, and the like (note: UVA, as used herein, should not be confused with the classification of sunlight as possessing UV-A, UV-B, or UV-C wavelengths).

Further, many UVA and/or light stabilizing additives are solvent based. In addition to potentially requiring a separate application step, solvent-based coatings often release volatile organics and/or other compounds upon curing, thereby creating environmental, health, and safety considerations.

United States Patent Publication 2016/0003989 and 2017/0066890 provide examples of films that must be applied separately in combination with a protective layer. As such, they are representative of the multi-step process for imparting protection against radiation. United States Patent Publication 2016/0194515 describes a specific composition intended to act as ultraviolet (UV) absorber. The background of invention portions of these disclosures are incorporated by reference as representative of the state of the art.

The efficacy of a coating additive intended for light stabilization and radiation protection can be measured by a variety of direct and indirect methods. That is, certain characteristics of the film are measured over time based upon exposure of that film to UV radiation under real-world conditions. Qualitative or quantitative metrics may be selected relating to the coating efficacy, permanence/durability, color, cracking/integrity, and/or other measures of quality. Non-limiting examples include ASTM D4329, D4587, D5894, D7869, and G155; ISO 4893-3 and SAE 2412, J2020, and J2527, as well any and all referenced documents and standards incorporated in those examples. Also, standard or specialized tests for weathering may be relevant, including ASTM C1257 and D1435; ISO 17025; and the like.

In view of the foregoing, a cost effective additive addressing all of these concerns would be welcome. Further, a light stabilizing additive that serves multiple purposes—including some of the other additive functions identified above—would be particularly helpful.

### SUMMARY OF INVENTION

One aspect of the invention comprises a light stabilizing (e.g., ultraviolet absorber) composition comprising a base resin including polyester, carboxylated polyester, and epoxy resins constituting at least 50 wt. % of the premixed composition, along with less than 2.5 wt. % of at least one triazine-based and/or hindered amine-based ultraviolet light inhibitor. This composition is extruded and reduced in particle size to a powder wherein at least 90 wt. % of particles are less than 20 micrometers. In one embodiment, the powder is combined with a silica carrier to produce a multi-faceted additive that may be incorporated in liquid or powder coating composition formulations. In another embodiment, the powder is provided separate from a silica carrier.

Further reference is made to the appended claims and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

The appended drawings form part of this specification, and any information on/in the drawings is both literally encompassed (i.e., the actual stated values) and relatively encompassed (e.g., ratios for respective data). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIG. 1 is a bar graph showing the comparative performance of the inventive light stabilizing additive at varying weight percentages against a conventional UVA additive at 0.5 wt. % and a blank containing no UVA. The results at each reported weight level are averaged across three separate coating platforms.

FIG. 2 is a time plot of the photo permanence of the inventive light stabilizing additive (solid line) against comparable formulations relying upon conventional UVA additives. As above, the results were averaged across three separate chemical platforms.

FIG. 3 reports the color protection afforded by the inventive light stabilizing additive at various weight percentages, in comparison to a blank and a conventional UVA. Again, the reported results were averaged across three separate chemical platforms.

FIG. 4 is a time plot of the gloss retention for the inventive light stabilizing additive in comparison to a conventional combination of hydrophilic UVA and hindered amine light stabilizers, as well as a blank.

### DETAILED DESCRIPTION

Reference will now be made in detail to exemplary embodiments of the present invention. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

Any elements described herein as singular can be pluralized (i.e., anything described as “one” can be more than one). Any species element of a genus element can have the characteristics or elements of any other species element of that genus. The described configurations, elements or complete assemblies and methods and their elements for carrying out the invention, and variations of aspects of the invention can be combined and modified with each other in any combination. As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

A high performance, multi-faceted light stabilizing additive that may be formulated for further specific functionalities is contemplated. Notably, according to at least some of the compositions and processes disclosed herein, the additive comes in a powder form but with liquefying capabilities. In one embodiment, it has at least nine different functional characteristics that constitute improvements compared to conventional UVA; for example, it is migration free, solvent-extraction free, has a high weathering resistance, improved flow and physical properties such as priming capability, color durability, high gloss retention, high yellowing resistance and extended photo-permanence.

The additive disclosed herein is multi-faceted and particularly advantageous because it is able to react with various curative types and, in addition to being effective as a light stabilizer and UVA additive, it can also be effective in improving physical properties (eliminating surface crack formation, retaining impact and strength, improving slip, increasing pencil hardness), as well as other flow characteristics, and it provides strong weathering resistance, gloss control, yellowing-resistance, and protection against thermal and light degradation.

One of the advantages of the additive disclosed herein in comparison to other UV coating additives is that the disclosed additive can be inserted directly into a smooth texture coating platform binder system such as polyurethane, hybrid, TGIC, and primid systems (manufacturers include Dow Industries, EMS, Kukdo Chemical Industry Co, Ltd., and Sun Polymers). For epoxy system platforms, Kukdo Epoxy Resins KD-211E, KD-211G, KD-242G, KD-243C and Dow's D.E.R 633U and Vantico GT7013 epoxy resin, the additive can be added at about 0.5% up to about 4.0% by weight of total binder. In addition, the inventive UV absorber additive can also be post added/blended at about 0.03% up to about 0.9% by weight to act as an extender to current UV absorbers in formulations. As used herein, hybrid coating platform binder systems have been in use since the mid-1970s and generally refer to systems relying upon two separate base resins (e.g., epoxy and polyester, etc.).

Further, the light stabilizing additive disclosed herein has liquifying capabilities allowing it to be added to liquid as well as powder formulations. The formulation may be combined with liquids such as water (preferably de-ionized and/or distilled), acetone, methyl-ethyl ketone (butanone), ethanol, and other, similar common industrial solvents, as well as combinations thereof. If the additive is combined with a liquid carrier, the formulation can volatilize after the initial coating. More significantly, the additive is initially provided in solid form in order to enable the formulator to decide upon the type and amount of solvents.

The additive relies on a combination of polyester resin with viscosity of 25-40 ps @ 200° C. and a T_{g} of 62-66° C., a carboxylated resin with a T_{g} of 60-65° C. and a viscosity of 15-22 ps @ 200° C. and an epoxy resin with a viscosity of 13.0-17.0 mPas and an equivalent weight of about 725-745 g/eq blended in conjunction with additional constituents such as polymeric curatives, UV Stabilizers, UV Inhibitors, catalysts, flow aids, anti-corrosion pigments, anti-oxidant agents, contrast agents, optical brighteners and oils, blended and extruded as masterbatch. The carboxylated polyester resin is saturated, so as to impart significantly greater durability in comparison to the individual polyester resin used in the described aspects (although even more generally, this type of carboxylated polyester is more durable than most polyester resins used in coating formulations today).

The optical brightener absorbs the invisible UV light and converts it to visible blue light. One particularly useful brightener is a derivative of trans-stilbene, containing amino and sulfonic acid functional groups on each of the two phenyl rings having the formula (H₂NC₆H₃SO₃H)₂C₂H₂. Other brighteners are known.

The introduction of untreated, medium particle sized (e.g., 150-190 m²/g specific surface area (N₂) via ISO 9277; ≤3.0% sieve reside 45 microns via ISO 2362-19; 8 to 13 microns d₅₀ via laser diffraction for average agglomerates) precipitated silica to act as a carrier significantly increases functionality of the additive. The silica carrier may be used in an amount of about 0.5 to 5.0% by weight based on the balance of the additive composition being 100% as shown in the table below. Alternatively, the silica carrier may be introduced after the additive composition is extruded and ground, as disclosed below.

In one embodiment, the additive is introduced to platform coating systems in an amount of about 0.5-1.5 wt. %. In accordance with one embodiment or implementation of the invention, conventional UV Absorbers or additives such as modified polyacrylates are not necessary. Addition of multiple, independent additives is no longer necessary in formulations owing to the multi-functional nature of the additive.

The table below provides general and specific details on the composition and manufacture of certain embodiments of the additive. As noted above, this additive possesses significant advantages in comparison to conventional UVA solutions now available.

| Exemplary | Min/max | | |
|---|---|---|---|
| weight | range, wt. % | Component | Examples and characteristics |
| 400 | 35.0 to 45.0 | Polyester resin | Preferably includes hydroxyl functionality; |
| | | | viscosity of 25-40 ps @ 200° C.; |
| | | | a T_{g} of 62-66° C. |
| 200 | 15.0 to 25.0 | Flow aid | contains polyethylene and polyester |
| | | (ricinoleic acid) | hydroxyl resins, along with curative, |
| | | | degasser, ricinoleic acid, and glass |
| | | | flake, on a silica carrier; see |
| | | | U.S. Pat. No 9,353,254 (incorporated |
| | | | by reference) |
| 100 | 7.0 to 12.0 | Saturated | carboxylated; viscosity |
| | | polyester resin | of 15-22 ps @ 200° C.; Tg |
| | | (carboxylated) | of 60-65° C. |
| 100 | 7.0 to 12.0 | Contrast agent | molecular weight of 230-235 g/mol; |
| | | | melting point of 1550-1600° C. |
| 50 | 3.0 to 7.0 | Epoxy resin | low molecular weight of about 735-745 g/eq |
| | | | and a viscosity of 13.0-17.0 mPas and an |
| | | | equivalent weight of about 735-745 g/eq; |
| | | | preferably a reaction product of |
| | | | epichlorohydrin and bisphenol A |
| 50 | 3.0 to 7.0 | Curative | blocked aliphatic and aromatic |
| | | (polyurethane) | polyisocyanate curative |
| 27 | 1.50 to 5.50 | Curative | Primid hydroxyalkylamide crosslinker; |
| | | (primid) | melting point between 118-125° C.; |
| | | | hydroxyl number of 620-700 mg KOH/g |
| 20 | 1.70 to 2.20 | Anti-oxidant | Phenolic; density of 1.15 g/ml @ 20° C.; |
| | | | melting range of 105-130° C. |
| 19 | 1.70 to 2.20 | Optical | Derivative of trans-stilbene, containing |
| | | brightener | amino and sulfonic acid functional groups |
| | | | on each of the two phenyl rings |
| 10 | 0.5 to 1.5 | Hardener | triglycidyllisocyanurate, blocked |
| | | | cycloaliphatic polyisocyanate, aromatic |
| | | | polyisocyanate curative |
| 9 | 0.3 to 2.4 | UV inhibitor(s) | Preferably, equal part mix of: (i) triazine |
| | | | based, molecular weight of 580-586 g/mol, |
| | | | melting range of 70° C.-80° C.; (ii) |
| | | | hindered-amine, molecular weight of 682-687 |
| | | | g/mol, melting range of 142° C.-154° C.; |
| | | | (iii) triazine based, molecular weight of 643-649 |
| | | | g/mol, density of 1.07/cm³ |
| 5 | 0.2 to 1.0 | Anti-corrosion | zinc phosphate; density of 3.0-4.0 g/ml; pH |
| | | pigment | of 6.5-7.3; oil absorption of 20-25 cm³/g |
| 5 | 0.2 to 7.0 | Oil | castor oil; molecular weight of 930-935 g/mol; |
| | | | boiling point of 310-315° C. (i.e., higher |
| | | | than the melting point of the base resins) |
| 3 | 0.1 to 0.8 | UV stabilizer | benzotriazole with a propane diol group |
| 2 | 0.1 to 0.5 | Catalyst | tin-based liquid catalyst stannous octoate |
| | | | pre-adsorbed onto a silica carrier |

Processing notes:
Admix polyester and epoxy resins in tumbler (40-60 min) or via high speed mixer, e.g. MIXACO (45-50 sec) until components are fully blended. Gravity feed admixture and extrude at 300 RPM and 400 g/min feed rate via single or twin screw extruder, either having three temperature zones respectively set at 60/60/140° F. Extruded sheet product is ground (e.g. Retch mill or coffee grinder) for 1-5 minutes to form a powder with particle size 10-15 micrometers.

A silica carrier composed of untreated, medium particle sized precipitated silica (45%-55%) is then added to the ground extrudate produced via the table above. This mixture is then re-extruded and blended using a Henschel high speed system for micronizing to form a preferred embodiment, with the additive's final particle size will be <5 μm. In other embodiments, the final ground extrudate from the table above can be ground to an optimized particle size (e.g., 100 nanometers to 5 micrometers) and adhered to a silica carrier such as (3-aminopropyl) trimethoxysilane and/or a silicone dioxide-precipitated amorphous silicate (45-55% active). Non-limiting examples of such carriers include Acematt HK450 or Sipernat 160, from Evonik, Germany, Zeolex 330 from Huber Inc., USA, and/or other forms of commercially available 3-aminopropyl triethoxysilane/silicone dioxide precipitated amorphous silicates.

Representative examples of polyester resins appropriate for use in the additive include certain types of polyester hydroxyl resins. These particular polyester hydroxyl resins include: Crylcoat 2401-2, Crylcoat 2471-4 (from Allnex) SP-100, SP-400 (from Sun Polymers) and Rucote 102, 108, and Rucote 121 (from Stepan Company). Representative curatives useful in one embodiment include, Crelan NI2 blocked cycloaliphatic polyisocyanate, Dow Chemical TGIC (triglycidyllisocyanurate), Epikure 101 Imidazole Adduct, Epikure P-108 DICY Imidazole Adduct, aliphatic and cycloaliphatic amine curing agent from Momentive Industries and phenolic hardener DEH84 from Dow Chemical.

Representative and suitable epoxy resins include Kukdo Epoxy resin KD-242H. KD-242H, which is a bisphenol-A type solid epoxy resin which has excellent flow characteristics. KD-242H has an epoxy equivalent weight specification of 660-720 (g/eq), a softening point of about 85° to 95° C., and a melt viscosity of specification of about 2200 to 2800 cps at 150° C. Suitable hardeners include Kukdo KD-410J, Epikure 101 and Dyhard 100.

Dow Chemical's 663U is a solid epoxy resin and is a standard medium molecular weight epoxy resin for powder coatings application. The resin has an epoxy equivalent weight specification of 730-820 (g/eq), a softening point specification of 92°-102° C. and a melt viscosity specification of 2000-4000 cps at 150° C. Suitable hardeners include Kukdo KD-401, KD-41, KD-410J, Epikure 101 and Dyhard 100.

Representative examples of epoxy-polyester resins useful in one embodiment include: Crylcoat 2401-2 and, Crylcoat 2471-4 from Allnex; SP-100 and SP-400 from Sun Polymers; and Rucote 102, 106, and Rucote 118 from Stepan Company.

Representative examples of UV Absorbers include CHISORB-P, CHISORB 234, CHISORB 593 and CHISORB 5582 from The Cary Company; ColorMatrix Ultimate 390, ColorMatrix Lactra SX, and OnCap UV Stabilizer from PolyOne; and Tinuvin 900, Tinuvin 405, and Tinuvin 292 from BASF.

U.S. Pat. No. 9,353,254, which is incorporated by reference, describes a powder coating flow aid appropriate for use in formulating the additive. This flow aid includes a polyethylene resin combined with a polyester hydroxyl resin. A polymeric curative, degassing agent, ricinoleic acid (i.e., 12-hydroxy-9-cis-octadecenoic acid), and glass flake are also used, and the flow aid is introduced to powder coating compositions by way of a silica carrier. The polyethylene is provided at between 3.1 to 9.5 wt. %, the polyester hydroxyl at 35 to 50 wt. %, the polymeric curative at 5.0 to 10 wt. %, the degassing agent at 0.25 to 2.0 wt. %, the ricinoleic acid at 0.5 to 3.0 wt. %, glass flakes at 20 to 50 wt. %, and the silica carrier being 0.5 to 5.0 wt. % of the flow aid's total weight. One particularly useful flow aid meeting these characteristics is sold as PF45 by Pison Stream Solutions Inc.

The additive as disclosed herein, when used in finished coating compositions, delivers the following characteristics and advantages in comparison to currently available UVA additives known to the inventors:
The additive relies on multiple chemical platforms, enabling the additive to react with various curative types in a polymeric matrix and imparting an improved resistance to surface cracking, enhanced slip, increased pencil hardness, and retention of impact resistance/tolerance;
The additive reduces and eliminates surface defects such as pinhole craters and orange peel, thereby significantly improving flow and leveling as the coating cures;
The additive prolongs the durability of the coating by minimizing cracking, controlling gloss, imparting yellowing resistance, and generally improving color qualities within the final coating;
The additive also imparts high thermal stability and environmental permanence in comparison to existing UVA solutions for coatings requiring high bake cycles or used in extreme environmental conditions;
The additive protects against thermal and light degradation within the coating; and
The additive delivers strong weathering resistance, up to 5,000 hours, which generally sustains the composition's physical properties and, accordingly, prolongs shelf life;

Further, it should be noted that while the additive disclosed herein nominally includes components that are common to conventional powder coatings (even to the point of creating a masterbatch as part of the formulation process), the ancillary, functional components (i.e., the non-resin components, such as anti-corrosion pigments, curative/hardeners, degassing agents, anti-oxidants, and the like) are not necessarily selected so as to make the additive a viable, stand-alone finished coating composition in its own right. That is, while the additive appears to have similarities to a conventional, finished powder coating composition, whether the specific, functional constituents selected for the additive could be useful in the initial extrusion of the additive itself irrelevant, as these functional constituents will be imparted to the formulation in which the additive is finally used.

Thus, the additive is specifically formulated to integrate with conventional finished liquid and powder coating compositions so as to deliver the desired effects with respect to scratch resistance, chemical resistance, gloss retention, and friction performance of the cured coating. This holistic approach to formulating an additive—by considering a combination of resins and functional components that deliver a synergistic effect—is, in the inventors' view, a stark departure from previous additives. Whereas legacy commercial additives have identified one or two chemicals as “active” or important contributors to the mar/scratch resistant additive's efficacy—with the additive itself then formulated to maximize the amount(s) of those active ingredients—the disclosed aspects of this invention acknowledge the significance of providing an entire binder system that itself melts and integrates with the finished coating composition to which it is added and, eventually, cured. In this manner, the inventive additive can be incorporated into most formulations without the need for further adjustment to account for the impact the additive itself might have on that formulation's final properties (e.g., flow, melt, etc.).

Further, by relying on a silica carrier, the inventive additive can be integrated seamlessly during the curing process. That is, the micronized additive (i.e., particle sizes between 100 nanometers and 5 microns) can be introduced to the finished coating composition by way of an inert carrier that will simply become part of the final, cured coating. Further, by associating the additive with the silica carrier, storage and handling of the additive is simplified.

One aspect of the disclosed formulations is that the amounts of each additive component are selected relative to ratio of multi-functional additive/additive to silica carrier. That is, the additive adheres to the silica carrier in known amounts, so that the combination additive-carrier is provided to the finished coating composition at the relatively low weight percentages contemplated herein. Further, given the aforementioned synergistic effects of the constituents of the additive, the relative (or “stoichiometric”) amounts of the constituents and silica carrier are important to the efficacy of the final additive. Preferably, when final extruded additive powder (i.e., in its ground form) is mixed with the silica carrier, the additive is at least 70 wt. %, of that mixture (i.e., additive +carrier) and, more preferably, between 75 to 90 wt. % with the remainder being provided as the silica carrier. Thus, between two to ten times more, by weight, of extruded, powdered additive is mixed with a corresponding mass of silica carrier. In a further embodiment, the weight ratio of extruded, powdered additive to silica carrier is at least 7:3, about 13:5, and no greater than 9:1.

The final additive platform contemplated herein can be cured for10 minutes @375° F. or 20 minutes @350° F., using a convection oven such as a laboratory oven (e.g., Blue M made in White Deer, Pa.). The additive is then milled or ground to a particle size that is appropriate for powder coating applications, with micronized sizes being most ideal when a silica carrier is used. In this manner, as little as 0.6 to 15 grams of additive for UVA properties per 1000 grams of finished coating powder can be effective when blending a finished powder coating composition, post extrusion (of the original coating composition). Alternatively, as noted above, 0.5 to 1.5 wt. % of the multi-functional, light stabilizing additive can be blended and extruded with/as part of the finished coating composition.

In another embodiment, a process for making a light stabilizing additive from the above-identified components is contemplated. Here, the components are first blended together by way of admixing in a tumbler, a Henschel high speed mixer MIXACO mixer, or by bag blending for either 25 seconds, 1 minute, 5 minutes, 10 minutes or up to 45 minutes depending on the time it takes for the admixture to be fully blended (i.e., visibly admixed without any apparent signs of incomplete comingling).

This admixed “premix” blend is gravity fed into the hopper of an appropriate extruder. The hopper then drops the premix into the extruder barrel, which is a heated steel cylinder with at least one auger-type screw rotating inside at a predetermined speed between 250 to 350 RPM. The feed rate for the premix into the barrel is between 350 g/min and 450 g/min, with the hopper and/or size of the opening forming the throat of the hopper being adjusted to set and control this rate.

Extruders appropriate for use in these operations may range in size from 19 mm, 26 mm, 32 mm, 50 mm, 80 mm, or larger. Depending upon desired processing times and equipment available, these extruders can be of either single or twin screw types. The preferred L:D (length:diameter) ratio of the screw depends on the size of the extruder and can vary from 20:1 to 30:1.

Hoppers can be independently selected and attached to the extruder. The types appropriate for use in the process contemplated herein can be selected from a conical hopper, wedge or chisel (plane-flow hopper), transition hopper, square opening hopper, and pyramid hopper. The hopper sizes will depend upon the extruder, as well as the possible load of premix it can hold, but they will generally accommodate a range from 10 kg (or ˜25 lbs.) to about 900 kg (or ˜2000 lbs.).

The screw(s) then advance the premix through the barrel and along three consecutive heating/cooling zones. The first zone (feed zone) is maintained at a heat between 55° C. and 70° C., followed by a second zone (compression zone) also set to a range between 55° C. and 70° C. Finally, the third zone (metering zone) is increased to between 130° C. and 150° C. before the blended and heated constituents are extruded.

As part of that extrusion process, the premix constituents will melt within the metering zone and then exit the barrel through a die. The die leads to a cooling belt, which provides a flat, ambient or deliberately chilled surface on which the extrudate cools into a sheet-like product. In turn, the cooling belt carries this sheet through a flaker (i.e., a multi-pronged apparatus which breaks the sheet into smaller pieces). In this manner, extruded premix flakes are formed.

These premix flakes are then delivered to a grinder (e.g., a mill, crusher, and/or similar device(s)) so as to reduce the flakes down to individual particle sizes of less than 20 microns. In a preferred embodiment, a majority of the flakes (by volume and/or by weight) will be between 5 and 20 microns. In still other embodiments, substantially all of the flakes (>95 vol. % and/or >95 wt. %) will possess this range of sizes. In this manner, extruded premix powder is formed.

Finally, the powder is further reduced in particle size to form the additive powder. Here again, the method could be by way of a mill, although a cyclone may be preferable based upon its ability to separate and extract the desired particle sizes. Additionally, or alternatively, sieves may be employed for the same purpose. To the extent milling and/or sieving yields particles outside the desired size range, large particles can be reintroduced to the mill/cyclone until the desired range is achieved. Particles that are too small can be stored and, when a sufficient quantity is collected, reprocessed (i.e., melted and formed into extruded premix flakes) in order to conserve raw materials while still achieving the desired particle size range.

Grinding machines appropriate for use can be any combination of an air classifying mill (which is an air swept mechanical impact mill with a dynamic air classifier designed to grind materials), a retch mill grinder, and/or a conventional coffee-type grinder. The extrudate is grounded for about 1-5 minutes at ambient temperatures and pressure to form the final powder coating formulation having a typical particle size of less than 20 microns. Conventional particle size analysis (using dedicated instruments and/or pursuant to methods published by ASTM and other similar organizations) can be used to refine the actual grinding times and/or to set quality control procedures and parameters. Notably, owing to the grinding machines identified herein, it is preferable to rely on methods based on non-spherical particles, although in some instances, it may be appropriate to assume spherical particles in order to simplify procedures. Optical inspection, using appropriate magnification, can ultimately confirm the best approach.

The additive powder should have a particle size between 5 and 15 microns. In one embodiment, at least 50 vol. % meets this criteria. In another, at least 50 wt. % is within the range. In still further, separate embodiments, at least 90 vol. % and at least 90 wt. % possess particle sizes between 5 and 15 microns. Embodiments also capture at least 95 vol. %, at least 95 wt. %, at least 99 vol. %, and at least 99 wt. %. Without necessarily wishing to be bound by any theory of operation, the inventors believe this range of particle sizes is significant to the extent the additive powder is used in conjunction with a silica carrier, as described above.

In yet another embodiment, a powder coating composition is contemplated using the light stabilizing additive described above. This final coating composition comprises about 85% to about 99.9% by weight of a finish powder coating platform and about 0.5% to about 1.5% by weight of the disclosed additive for controlling the surface tension. Unless otherwise stated, all percentages stated herein are weight percentages based on the total powder coating composition or, when considered in context, of the additive itself. Powder coating platforms containing the additive component may be preferably added to a conventional thermosetting powder coating resin material. The material is selected from one more of the groups of epoxy, epoxy-polyester, silicone, hydroxyl polyester, TGIC-polyester and TGIC-free polyester resins. Conventional additives, such as hardeners, pigments, UV stabilizers, UV inhibitors, curatives, catalysts, pigments and flow aids may be included in the powder coating material composition.

In identifying appropriate resins for the additive, alternatives can be identified so long as they have the same chemical composition and similar characteristics (e.g., viscosity, T_{g} temperature, differential scanning calorimetry, etc.) as the exemplary grades of material identified herein.

Further, coating compositions having the additive can be applied on various substrate types such as plastic, metal, aluminum, wood, concrete, paper, cloth, stucco and a host of other materials to act as a coating. Additional, exemplary resins and additives, suitable for such coating compositions, as disclosed in any of the references identified herein are also incorporated by reference. Still other components may be mixed into or formed as part of the extruded powder.

### EXAMPLES

A series of comparative formulations were prepared and tested under varying conditions to show the performance of the inventive light stabilizer additive in various functionalities: tensile strength, photo permenance, color protection and gloss retention. The data provided were obtained through a series of analysis comparing formulations with the inventive light stabilizer additive (in varying weight percentages), formulations with prior art conventional UVA and control formulations with no light stabilizer or UVA. Three separate formulations based upon primid, polyurethane, and TGIC chemistry platforms were developed for each set of analysis. The data collected, including the reported results for a given weight percentage of light stabilizer (or prior art components), were averaged across all platforms tested.

Unless otherwise noted, the composition, method of manufacturing, method of application to a substrate, and the type of substrate were identical for each test in the series. To the extent some samples in a given test varied the weight percentage of light stabilizing additive or prior art compound (i.e., ultraviolet light absorber, hydrophilic UVA, or hindered amine light stabilizer) provided to the composition, it will be understood that the amounts of other components in the formulation were adjusted proportionally but without otherwise changing the composition.

Generally speaking, a variety of services, instruments, and associated bulletins, articles, and operating procedures for the QUV Accelerated Weathering Tester available from Q-Lab Corporation headquartered in Westlake, Ohio, USA (www.q-lab.com/products) (QUV) proved useful in the testing. A wide range of standardized and published methods and protocols can be performed in conjunction with the QUV, including AAMA 624; AATCC TM186; ASTM C1257, C1442, C1501, C1519, C732, C734, C793, D1148, D1670, D3424, D3451, D4101, D4329, D4434, D4587, D4674, D4799, D4811, D5208, D5894, D6577, D750, D882, D904, D925, E3006, F1164, F1945, G151, and G154; EN 13523-10(DIN); GM 9125P; IEC 61215 and 61345; ISO 11507(EN)(DIN), 29664, 4891-1(EN)(DIN), and 4892-3(EN)(DIN); and SAE J2020.

The QUV essentially reproduces the damage caused by sunlight, rain and dew. In a few days or weeks, the QUV UV tester reproduces the environmental stresses inflicted upon coated substrates in a manner that represents months or years of outdoor exposure. In order to simulate outdoor weathering, the QUV accelerated tester exposes materials to alternating cycles of UV light and moisture at controlled, elevated temperatures.

### A. Tensile Strength

Tensile strength is the capacity of a material or structure to withstand loads tending to elongate or, essentially, the resistance of that material to break under tension.

A set of control formulations contained no light stabilizer or UVA (labeled as “Blank” in the Figures), while a separate set of conventional formulations relied upon 0.5 wt. % of a prior art UVA. Additional sets of formulations relied upon 0.5 wt. %, 1.0 wt. %, and 2.0 wt. % of the inventive light stabilizer additive described in the Table above. The sets were otherwise comparable in all other respects.

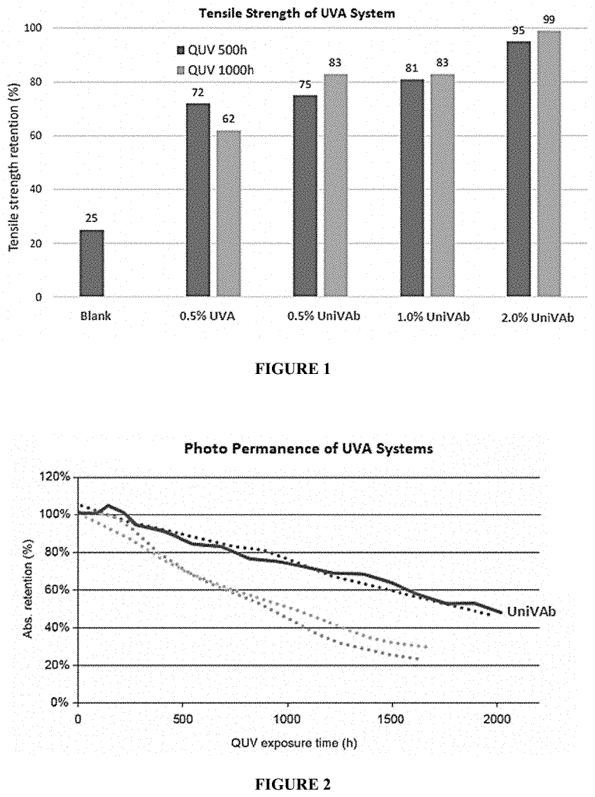

These formulations were prepared and coated onto identical substrates and subjected to prolonged testing in the QUV. The control was tested only for 500 hours, while all other substrates included data at 500 and 1,000 hours. The results from each set were then averaged and reported in FIG. 1.

Not surprisingly, the control performed poorly, retaining only 25% of its original tensile strength after 500 hours in the QUV. Similarly, the substrates coated with conventional UVA formulations retained only about 70% of their original tensile strength, with an appreciable deterioration as the time on test was extended. In contrast, all formulations realized higher levels of performance as the weight percent of the inventive light stabilizing additive was increased within the formulation.

### B. Photo Permanence

Photo Permanence is the ability of a coating to retain pigmentation and other properties including hardness, color exactness, gloss and chalking. Here again, the QUV was used over a 2,000 hour interval, with periodic data points taken at 500, 1,000, 1,500, and 2,000 hours in the test chamber.

FIG. 2 reports averaged results for three different chemistries all employing 3 wt. % of the inventive additive disclosed in the Table above (shown as a solid line labeled “UniVAb”). The remaining data reported in FIG. 2 (shown as three, distinct broken lines) relates to conventional UVAs in comparable, averaged platforms. As above, the inventive light stabilizer outperformed all conventional additives.

### C. Color Protection

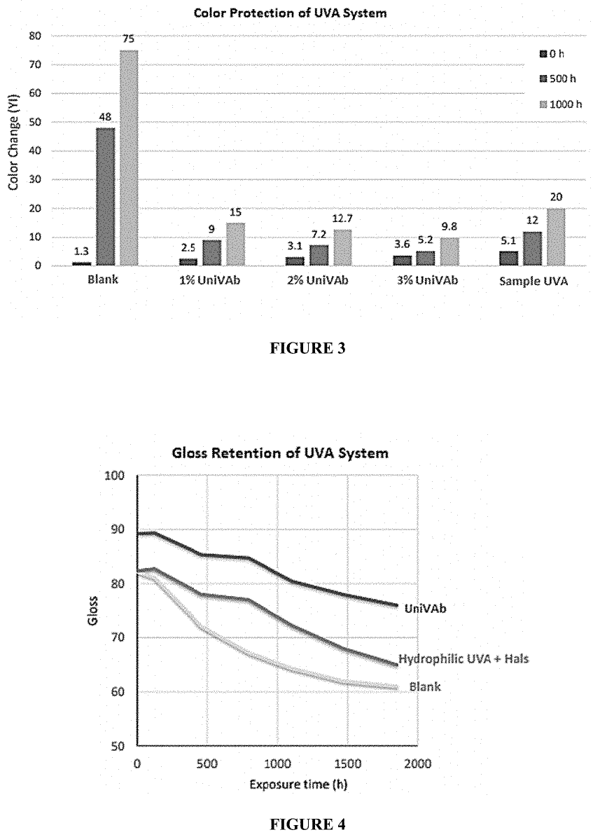

Color Protection relates to how little color is lost after a certain period of time. As above, comparable formulations were tested, with the inventive additive provided at a range of differing weight percentages (1, 2, and 3 wt. %). With reference to FIG. 3, the results of the control group and the group coated with conventional (“sample”) UVA were similar to those reported above.

In this instance, the control group (“blank”) quickly exhibited significant changes in color over the 1,000 hour period in the QUV. In comparison, the group coated with conventional UVA also degraded at about twice the rate of the inventive additive. Also, as the amount of inventive additive was increased within the formulation, a corresponding improvement in color protection was realized.

### D. Gloss Retention

Gloss Retention refers to a coating's ability to maintain its gloss. It is a measure of coating durability. With reference to FIG. 4, 2 wt. % of the inventive additive (“UniVAb”) was tested alongside a control (“Blank”) and a formulation combining conventional hydrophilic UVA and hindered amine light stabilizers (“Hydrophillic UVA+Hals”). Data points were taken at various intervals (reported hours) in the QUV.

Both initially and throughout the test, the inventive additive delivered significant gloss retention advantages.

In view of the foregoing, one aspect of the invention includes a formulation for an UVA additive including any combination of the following elements:
at least 50.0 wt. % of base resins including a polyester resin, a carboxylated polyester resin, and an epoxy resin;
between 15.0 to 25.0 wt. % of a flow aid including polyethylene and polyester hydroxyl resins with ricinoleic acid on a silica carrier;
between 0.1 to 2.5 wt. % of at least one ultraviolet inhibiting compound, each of said compounds being triazine-based or hindered-amine-based and each having a molecular weight between 580 and 687 g/mol;
a remainder consisting of a polyurethane curative, a primid curative and one or more functional constituents selected from: a contrast agent, an anti-oxidant, an optical brightener, a hardener, an oil having a boiling point above each melting point for the polyester, carboxylated polyester, and epoxy resins, an anti-corrosion pigment, a benzotriazole-based ultraviolet stabilizer, and a tin-based catalyst.
wherein the additive is extruded so that at least 90 wt. % of particles comprising the additive have a size of 20 micrometers or less;
wherein at least 90 wt. % of the particles have a size between 5 and 15 micrometers;
wherein the particles are mixed with a silica carrier;
wherein the base resins consist essentially of a polyester resin, a carboxylated polyester resin, and an epoxy resin;
wherein between 3.0 to 7.0 wt. % is the polyurethane curative and between 1.5 to 5.5 wt. % is the primid curative;
wherein between 7.0 to 12.0 wt. % is the contrast agent, between 1.7 to 2.2 wt. % is the anti-oxidant, between 1.7 to 2.2 wt. % is the optical brightener, between 0.5 to 1.5 wt. % is the hardener, between 0.2 to 7.0 wt. % is the oil, between 0.2 to 1.0 wt. % is the anti-corrosion pigment, between 0.1 to 0.8 wt. % is benzotriazole-based ultraviolet stabilizer, and between 0.1 to 0.5 wt. % is the tin-based catalyst;
wherein between 35.0 to 45.0 wt. % is the polyester resin;
wherein between 7.0 to 12.0 wt. % is the carboxylated polyester resin;
wherein between 3.0 to 7.0 wt. % is the epoxy resin;
wherein three ultraviolet inhibiting compounds are provided as follows: (i) a triazine-based compound having a molecular weight of 580-586 g/mol; (ii) a hindered-amine-based compound having a molecular weight of 682-687 g/mol; and (iii) a triazine-based compound having a molecular weight of 643-649 g/mol;
wherein the functional constituents include between 0.5 to 5.0 wt. % of a silica carrier;
wherein the additive is extruded into particles and the particles are mixed with a silica carrier;
wherein the extruded particles are mixed with the silica carrier at a weight ratio of between 7:3 and 9:1;
wherein the optical brightener is present and comprises a derivative of trans-stilbene, containing amino and sulfonic acid functional groups on each of the two phenyl rings; and
wherein the polyester resin is a polyester hydroxyl resin.

In another aspect, chemical coating compositions are contemplated. In particular, these coating compositions include an ultraviolet absorber additive according to any of the combination of elements described in the preceding paragraph. Further, these chemical coating compositions are in powdered form and also comprise a coating platform binder system selected from epoxy, polyurethane, hybrid, triglycidyllisocyanurate, and primid. Separately, a chemical coating formulation is manufactured so as to include a UV absorber, but here between 0.03 and 0.9 wt. % of any one of the additives contemplated in the preceding paragraph are blended into the formulation to serve as a UV extender.

In a still further aspect of the invention, a method of imparting ultraviolet absorbance or resistance to a chemical coating composition is contemplated. Here, at least 50 wt. % of resins, including at least one polyester resin and an epoxy resin, are admixed with a remainder including a primid curative, a polyurethane curative, at least one ultraviolet inhibitor, a catalyst and flow aid to create an admixture. The admixture is then extruded and ground into particles having a particle size of less than 20 micrometers to create a powdered extrudate, and a silica carrier is then mixed with the powdered extrudate to form a flow aid. Finally, the flow aid is provided to a chemical coating composition. The chemical coating composition may then be applied and cured. In other iterations of this method, additional functional components are included in the admixture (as identified above, in terms of composition and/or weight percentage) prior to extrusion. Also, a further inventive method contemplates mixing the silica carrier with the powdered extrudate at any weight ratio between 3:7 and 1:9 (silica carrier:powdered extrudate). Finally, the chemical coating composition may be in liquid or powdered form, prior to curing. Notably, a still further aspect of the invention involves a method of manufacturing a UV absorber additive according to these same steps and limitations.

Unless specifically noted, all tests and measurements are conducted in ambient conditions (e.g., temperature, pressure, humidity, etc.) according to commonly accepted measurement protocols (e.g., such as those regularly published by ASTM International) and relying upon commercially available instruments according to the manufacturer-recommended operating procedures and conditions. Unless noted to the contrary (explicitly or within the context of a given disclosure), all mass measurements are in grams, temperature measurements in degrees Celsius, and all percentages based upon weight percentages.

Although the embodiments of this disclosure have been disclosed, it is to be understood that the present disclosure is not to be limited to just the described embodiments, but that the embodiments described herein are capable of numerous rearrangements, modifications and substitutions without departing from the scope of the claims hereafter. It is, of course, not possible to describe every conceivable combination of components or methodologies for purposes of describing the present specification, but one of ordinary skill in the art may recognize that many further combinations and permutations of the present specification are possible. Furthermore, to the extent that the term “includes” is used in either the detailed description or the claims, such term is intended to be inclusive in a manner similar to the term “comprising” as “comprising” is interpreted when employed as a transitional word in a claim. The claims as follows are intended to include all modifications and alterations insofar as they come within the scope of the claims or the equivalent thereof.

1. A light stabilizing additive for chemical coating compositions comprising:
at least 50.0 wt. % of base resins including a polyester resin, a carboxylated polyester resin, and an epoxy resin;
between 15.0 to 25.0 wt. % of a flow aid including polyethylene and polyester hydroxyl resins with ricinoleic acid on a silica carrier;
between 0.1 to 2.5 wt. % of at least one ultraviolet inhibiting compound, each of said compounds being triazine-based or hindered-amine-based and each having a molecular weight between 580 and 687 g/mol; and
a remainder consisting of a polyurethane curative, a primid curative, and one or more functional constituents selected from: a contrast agent, an anti-oxidant, an optical brightener, a hardener, an oil having a boiling point above each melting point for the polyester, carboxylated polyester, and epoxy resins, an anti-corrosion pigment, a benzotriazole-based ultraviolet stabilizer, and a tin-based catalyst.

2. The additive of claim 1 wherein the additive is extruded so that at least 90 wt. % of particles comprising the additive have a size of 20 micrometers or less.

3. The additive of claim 2 wherein at least 90 wt. % of the particles have a size between 5 and 15 micrometers.

4. The additive of claim 3 wherein the particles are mixed with a silica carrier.

5. The additive of claim 1 wherein the base resins consist essentially of a polyester resin, a carboxylated polyester resin, and an epoxy resin.

6. The additive of claim 1 wherein between 3.0 to 7.0 wt. % is the polyurethane curative and between 1.5 to 5.5 wt. % is the primid curative.

7. The additive of claim 6 wherein between 7.0 to 12.0 wt. % is the contrast agent, between 1.7 to 2.2 wt. % is the anti-oxidant, between 1.7 to 2.2 wt. % is the optical brightener, between 0.5 to 1.5 wt. % is the hardener, between 0.2 to 7.0 wt. % is the oil, between 0.2 to 1.0 wt. % is the anti-corrosion pigment, between 0.1 to 0.8 wt. % is benzotriazole-based ultraviolet stabilizer, and between 0.1 to 0.5 wt. % is the tin-based catalyst.

8. The additive of claim 1 wherein between 35.0 to 45.0 wt. % is the polyester resin.

9. The additive of claim 1 wherein between 7.0 to 12.0 wt. % is the carboxylated polyester resin.

10. The additive of claim 1 wherein between 3.0 to 7.0 wt. % is the epoxy resin.

11. The additive of claim 1 wherein three ultraviolet inhibiting compounds are provided as follows: (i) a triazine-based compound having a molecular weight of 580-586 g/mol; (ii) a hindered-amine-based compound having a molecular weight of 682-687 g/mol; and (iii) a triazine-based compound having a molecular weight of 643-649 g/mol.

12. The additive of claim 1 wherein the functional constituents include between 0.5 to 5.0 wt. % of a silica carrier.

13. The additive of claim 1 wherein the additive is extruded into particles and the particles are mixed with a silica carrier.

14. The additive of claim 13 wherein the extruded particles are mixed with the silica carrier at a weight ratio of between 7:3 and 9:1.

15. The additive of claim 1 wherein the optical brightener is present and comprises a derivative of trans-stilbene, containing amino and sulfonic acid functional groups on each of the two phenyl rings.

16. The additive of claim 1 wherein the polyester resin is a polyester hydroxyl resin.

17. A chemical coating composition including between 0.1 to 15.0 wt. % of the additive of claim 14.

18. A chemical coating composition including between 0.1 to 15.0 wt. % of the additive of claim 1.

19. The chemical coating composition according to claim 18 wherein the chemical coating composition is in powdered form and further comprises a coating platform binder system selected from epoxy, polyurethane, hybrid, triglycidyllisocyanurate, and primid.

20. A chemical coating composition including between 0.1 to 15.0 wt. % of the additive of claim 7.

21. A manufactured chemical coating formulation having at least one UV absorber, said formulation comprising the additive of claim 1 at between 0.03 to 0.9 wt. % (inclusive of the formulation and the additive).

22. A chemical coating composition having an epoxy-based coating platform binder system including between 0.5 and 4.0 wt. % of the additive of claim 1.
